(19) United States
(12) Patent Application Publication
(10) Pub. No.: US 2003/0159482 A1
(43) Pub. Date: Aug. 28, 2003

(54) Variable tubular lock

(76) Inventor: Wu-Chang Liao, Taipei Hsien (TW)

Correspondence Address: Samuels, Gauthier & Stevens LLP, Suite 3300, 225 Franklin Street, Boston, MA, 02110, US

(21) Appl. No.: 10/335,669

(22) Filed: Jan. 2, 2003

(30) Foreign Application Priority Data
Feb. 25, 2002 (TW) 91202218

(51) Int. Cl. E05B 27/08

(52) U.S. Cl. 70/491

(57) ABSTRACT

A variable tubular lock comprising a lock body and a key is disclosed. The lock body comprises a casing, a lower pin seat inserted in the casing, a spindle provided with an upper pin seat, a plurality of springs and plural sets of cylindrical upper pins and cylindrical lower pins. This variable tubular lock is characterized in that the inner edge of a keyhole in the casing is provided with one or more protruding blocks, axial grooves for the protruding block passing through and an annular groove for receiving the protruding block and spinning the key. With this structure, the tubular lock can be prevented itself from being unlocked by a common unlocking device. Further, with the number and the position arrangement of the protruding blocks and the axial grooves, the variation of the lock codes can be substantially increased and thus the security of the tubular lock is significantly improved.

### FIELD OF INVENTION

The present invention relates to an improved tubular lock. More specifically, the present invention relates to a tubular lock which can prevent itself from being unlocked by a common unlocking device and increase the variation of the lock codes.

### BACKGROUND OF THE INVENTION

The applicant has devoted himself to manufacturing locks and associated components for several years. Since tubular locks can be widely applied to many fields, such as computer, video game, elevator, door lock, burglarproof lock for mobile and motorcycle, automatic paying gate, slot machine, etc., the demand for the security of the tubular locks is increasing. However, the security of conventional tubular locks (as shown in FIG. 1) are significantly deteriorated since unlocking devices (as shown in FIG. 2) for tubular locks are created.

As shown in FIG. 2, for example, a simple unlocking device 200 available on the market comprises a tubular spindle body 202 and a handle 201. The tubular spindle body is provided with a plurality of longitudinal grooves 203. Each longitudinal groove 203 is coupled with a metal piece 204 peripherally provided an annular retaining clasp 205 for retaining the metal pieces 204 to a certain degree.

As shown in FIG. 3, when the unlocking device 200 is inserted into a lock body 100 of a conventional tubular lock and the user slightly pushes the handle 201, the metal pieces 204 in the longitudinal grooves 203 are subjected to the pushing force applied by corresponding cylindrical upper pins 105 and thus are gradually retracted toward the handle 201. Since the retaining force of the annular retaining clasp 205 and the action force applied by the metal pieces 204 to the cylindrical upper pins 105, cylindrical lower pins 106 and springs 104 gradually become balanced, after slightly pushing the handle 201 for several times, each metal piece 204 pushes the corresponding upper pin 105 and lower pin 106 to a critical point. Therefore, the locking between an upper pin seat 107 and a lower pin seat 103 of the rotating shaft is eliminated so as to rotate the rotating shaft. This achieves the unlocking operation of the tubular lock.

The above unlocking operation can be simply achieved by inserting the unlocking device 200 having the same amount of metal pieces 204 as that of the corresponding pins together with the pushing and drawing of the unlocking device. As a result, the security of the tubular lock is significantly deteriorated.

### SUMMARY OF THE INVENTION

In view of the above drawbacks of conventional tubular locks, this invention provides an improved variable tubular lock. This invention can effectively prevent itself from being unlocked by a common unlocking device, increase the variation of lock codes and thus substantially improve the security of tubular locks without changing the size, usage and convenience of existing tubular locks.

One object of this invention is to provide a variable tubular lock capable of efficiently defeating the unlocking devices for tubular locks.

Another object of this invention is to provide a variable tubular lock capable of prevent itself from being unlocked by a common unlocking device without changing the size, usage and convenience of existing tubular locks.

Another object of this invention is to provide a variable tubular lock capable of substantially increasing the variation of lock codes.

Another object of this invention is to provide a variable tubular lock capable of significantly improving the security of tubular locks.

Another object of this invention is to provide a variable tubular lock capable of efficiently increasing the chance to use tubular locks.

### BRIEF DESCRIPTION OF THE DRAWINGS

The structure, features and functions of this invention will be described in detail with reference to the following description together with the accompany drawings, in which:

FIG. 1 is an exploded view showing a conventional tubular lock;

FIG. 2 is a schematic view showing an unlocking device for a conventional tubular lock;

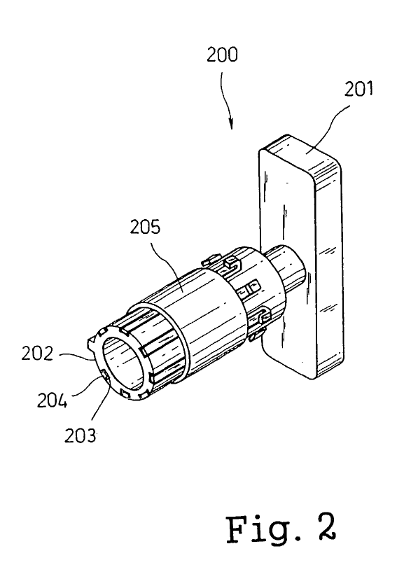

FIG. 3 is an exploded view showing the operation of the conventional tubular lock and the unlocking device of FIG. 2;

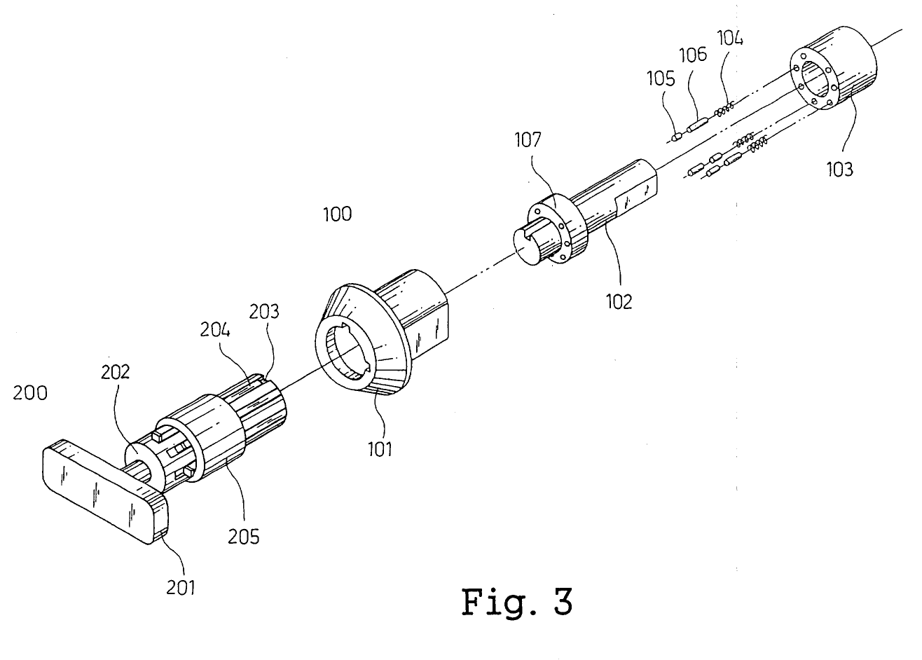

FIG. 4 is an exploded view showing the variable tubular lock in accordance with this invention;

FIG. 5 is a cross sectional view showing the variable tubular lock in accordance with this invention;

FIG. 6 is a schematic view showing examples of the type, number and position arrangement of the axial grooves provided correspondingly to the protruding blocks of the variable tubular lock in accordance with this invention.

### DETAILED DESCRIPTION OF THE PREFERRED EMBODIMENT

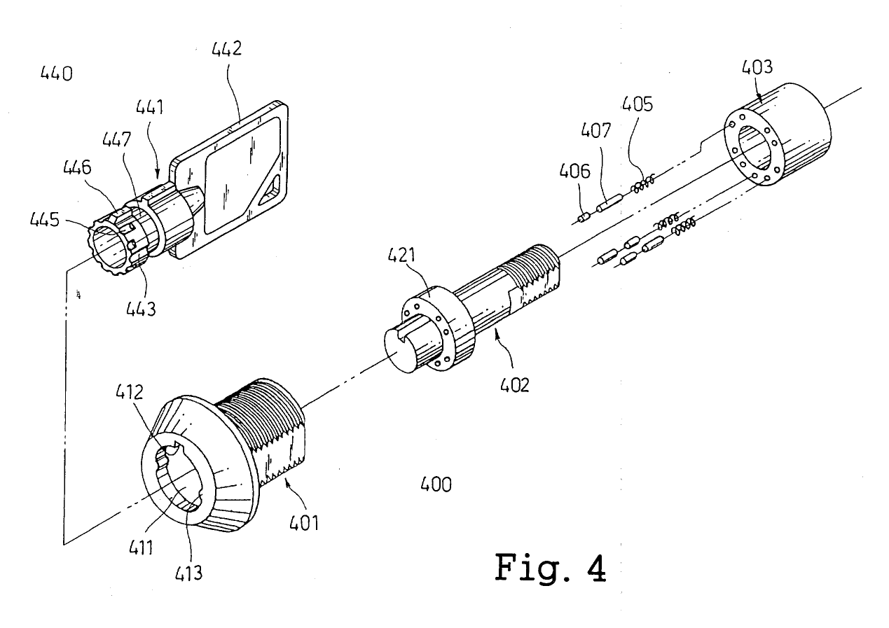

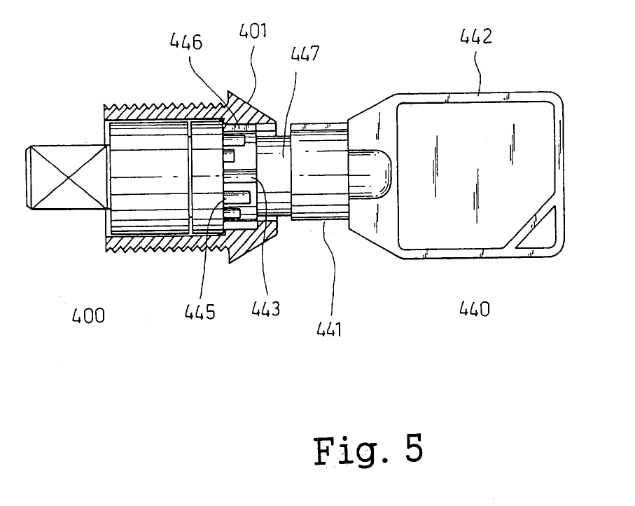

As shown in FIGS. 4 and 5, the variable tubular lock in accordance with this invention mainly includes a lock body 400 and a key 440. The lock body 400 comprises a casing 401, a lower pin seat 403 inserted in the casing 401, a spindle 402 provided with an upper pin seat 421, a plurality of springs 405 and plural sets of cylindrical upper pins 406 and cylindrical lower pins 407. The inner edge of a keyhole 411 in the casing 401 is provided with a notch 412 for an outer protruding key 446 passing through and one or more protruding blocks 413. The outer protruding key is provided on the periphery of the key. The key 440 is formed of a key tube 441 and a key handle 442. The key tube 441 is provided with serrations 445 corresponding to the cylindrical upper pins. The length or depth of each serration is not identical to each other. Further, axial grooves 443 and an annular groove 447 are provided between the serrations 445. The axial grooves 443 are for the protruding block 413 passing through and the annular groove 447 is for receiving the protruding block 413 and spinning the key 440.

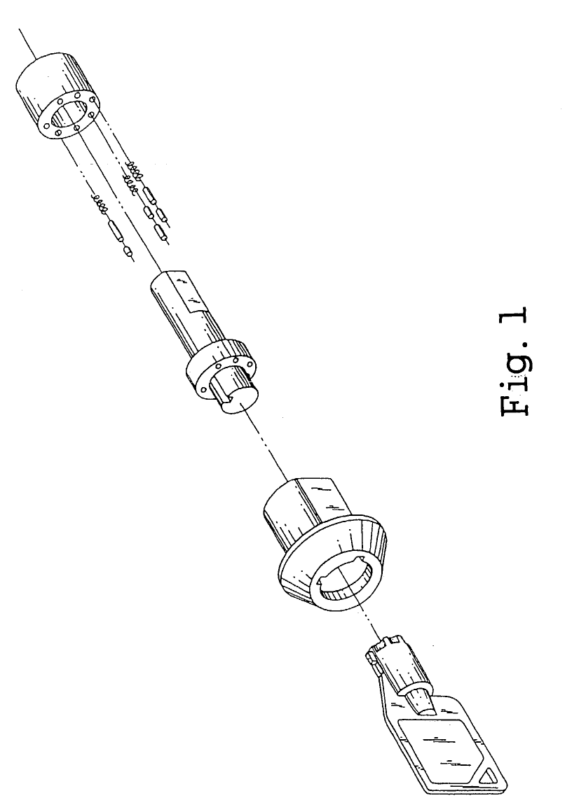

As shown in FIGS. 1, 4 and 5, the unlocking operation of the tubular lock in accordance with this invention is achieved by corresponding the cylindrical upper pins of different lengths to the different depths of serrations 445 on the key 440, which is similar to that of a conventional tubular lock. Further, the convenience and the usage of this invention are still properly maintained.

This invention is different from the conventional tubular lock by providing one or more protruding blocks 413 (e.g. two protruding blocks are shown in FIG. 4) on the inner edge of the keyhole 411 of the casing 401. The axial grooves 443 and the annular groove 447 are provided between the serrations 445. The axial grooves 443 are for the protruding blocks 413 passing through and the annular groove 447 is for receiving the protruding block 413 and spinning the key 440. Since the protruding blocks 413 are provided on the inner edge of the keyhole 411, the above-mentioned unlocking device 200 can not be inserted into the keyhole 411. Even some grooves corresponding to the protruding blocks 413 are provided on the unlocking device 200 for smoothly inserting into the keyhole 411, since the metal piece 204 in the unlocking device 200 can not be segmented and it is impossible to provide the annular groove of this invention for the restriction of the retaining clasp 205, the protruding blocks of this invention prevent the unlocking device 200 from spinning. Therefore, this invention can not be unlocked by a common unlocking device 200.

According to the above, this invention can efficiently prevent itself from being unlocked by a common unlocking device.

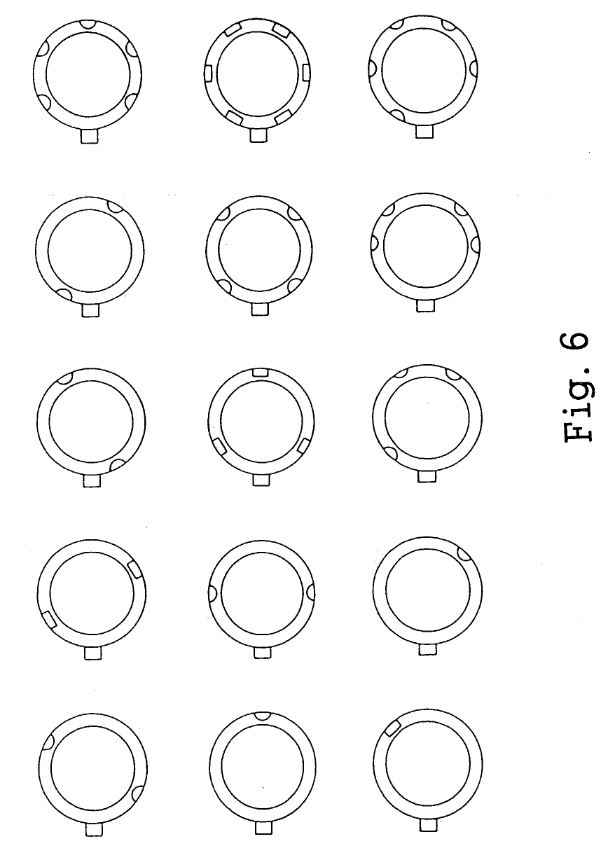

FIG. 6 is a schematic view showing examples of the type, number and position arrangement of the axial grooves 403 provided corresponding to the protruding blocks 413 in the key 400 of the variable tubular lock in accordance with this invention. As shown in FIG. 6, the shapes of the protruding blocks 413 and the axial grooves 443 are not limited to a certain shape, arc, square, triangle or any other shape can be used as long as the protruding blocks 413 and the axial grooves 443 correspond to each other or complement in shape. Further, the numbers of the protruding blocks 413 and the axial grooves 443 are not limited and could be one, three or any number. Moreover, the position arrangement is not limited to the embodiments shown in the specification. Therefore, the number and the arrangement of the protruding blocks 413 and the axial grooves 443 can be unlimited. Besides, together with the number and the depth of the serrations 445, the variation of lock codes of this invention can be numerous.

According to the above, the variable tubular lock of this invention is capable of efficiently defeating the unlocking devices for tubular locks, substantially increasing the variation of lock codes, significantly improving the security of tubular locks and efficiently increasing the chance to use tubular locks.

What is claimed is:

1. A variable tubular lock, comprising a lock body and a key, wherein the lock body comprises a casing, a lower pin seat inserted in the casing, a spindle provided with an upper pin seat, a plurality of springs and plural sets of cylindrical upper pins and cylindrical lower pins, and characterized in that
the inner edge of a keyhole in the casing is provided with one or more protruding blocks, axial grooves for the protruding block passing through and an annular groove for receiving the protruding block and spinning the key.

2. The variable tubular lock according to claim 1, wherein the shapes of the protruding blocks and the corresponding axial grooves can be arc, square, triangle or any other shape.
